(19) United States
(12) Patent Application Publication
(10) Pub. No.: US 2025/0118808 A1
(43) Pub. Date: Apr. 10, 2025

(54) ELECTRODE BODY AND BATTERY

(71) Applicant: TOYOTA JIDOSHA KABUSHIKI KAISHA, Aichi-ken (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/890,757

(22) Filed: Sep. 20, 2024

(30) Foreign Application Priority Data
Oct. 5, 2023 (JP) 2023-173835

(51) Int. Cl. H01M 10/0583

(52) U.S. Cl. CPC H01M 10/0583

(57) ABSTRACT

An electrode body, including a first electrode layer, a second electrode layer, and a separator that is disposed between the first electrode layer and the second electrode layer, the first electrode layer having a projecting portion that projects toward a side of the separator, and the second electrode layer having a recessed portion at a position facing the projecting portion of the first electrode layer.

### CROSS-REFERENCE TO RELATED APPLICATION

This application is based on and claims priority under 35 USC 119 from Japanese Patent Application No. 2023-173835 filed on Oct. 5, 2023, the disclosure of which is incorporated by reference herein.

### BACKGROUND

### Technical Field

The present disclosure relates to an electrode body and a battery.

### Related Art

Lithium ion secondary batteries are typically produced by injecting an electrolytic solution into an exterior body in which an electrode body, which includes an electrode and a separator, is accommodated. As a means for increasing an electrode density, the electrode body is subjected to a treatment such as pressurizing at high pressure or bonding an electrode to a separator with an adhesive or the like. The treatment may cause difficulty in permeation of an electrolytic solution into the electrode body, and improvement in efficiency of the liquid injection operation is desired.

As a method for improving the permeability of an electrolytic solution into an electrode body, for example, Japanese Patent Application Laid-Open (JP-A) No. 2002-15773 proposes a method of providing, when bonding an electrode and a separator that constitutes an electrode body, a portion at which the electrode and the separator are not bonded to each other.

Since the method described in JP-A No. 2002-15773 requires a process of providing a portion at which the electrode and the separator are not bonded to each other in order to increase the permeability with respect to an electrolytic solution, there is room for improvement in operating efficiency.

### SUMMARY

In view of the foregoing, an object of an embodiment of the present disclosure is to provide an electrode body that exhibits improved permeability with respect to an electrolytic solution with a simple configuration; and a battery including the electrode body.

The means for solving the above-described problem include the following embodiments.
<1> An electrode body, including a first electrode layer, a second electrode layer, and a separator that is disposed between the first electrode layer and the second electrode layer,
the first electrode layer having a projecting portion that projects toward a side of the separator, and
the second electrode layer having a recessed portion at a position facing the projecting portion of the first electrode layer.
<2> The electrode body according to <1>, wherein, in the first electrode layer, a region corresponding to the projecting portion is lower in density than a region around the projecting portion.
<3> The electrode body according to <1> or <2>, wherein, in the second electrode layer, a region corresponding to the recessed portion is higher in density than a region around the recessed portion.
<4> The electrode body according to any one of <1> to <3>, wherein the first electrode layer is a negative electrode layer and the second electrode layer is a positive electrode layer.
<5> The electrode body according to any one of <1> to <4>, wherein the second electrode layer has a projecting portion that projects toward the side of the separator, and the first electrode layer has a recessed portion at a position facing the projecting portion of the second electrode layer.
<6> A battery, including the electrode body according to any one of <1> to <5>.

According to an embodiment of the present disclosure, an electrode body that exhibits improved permeability with respect to an electrolytic solution with a simple configuration, and a battery including the electrode body, are provided.

### BRIEF DESCRIPTION OF THE DRAWINGS

Exemplary embodiments of the present disclosure will be described in detail based on the following figures, wherein:

FIG. 1 is a sectional view schematically illustrating an example of a configuration of an electrode body;

FIG. 2 is a sectional view schematically illustrating an example of a configuration of an electrode body;

FIG. 3 is a diagram schematically illustrating an example of application of a battery to an electric vehicle;

FIG. 4 is a diagram schematically illustrating an example of a configuration of a battery module;

FIG. 5 is a diagram schematically illustrating an example of a configuration of a battery module; and

FIG. 6 is a diagram schematically illustrating an example of a configuration of a battery cell included in a battery module.

### DETAILED DESCRIPTION

In the present disclosure, a numerical range indicated by using “to” means a range in which the numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only an independent step, but also a step that cannot be clearly distinguished from another step as long as the intended purpose of the step is achieved.

In a case in which an exemplary embodiment is explained in the present disclosure with reference to the drawings, the configuration of the exemplary embodiment is not limited to the configuration illustrated in the drawings. Furthermore, sizes of members in the respective drawings are conceptual, and relative relationships between sizes of members are not limited thereto.

### Electrode Body

The electrode body according to the present disclosure is an electrode body including a first electrode layer, a second electrode layer, and a separator that is disposed between the first electrode layer and the second electrode layer,
the first electrode layer having a projecting portion that projects toward a side of the separator, and
the second electrode layer having a recessed portion at a position facing the projecting portion of the first electrode layer.

In a general method for manufacturing a battery, an electrolytic solution is injected into an exterior body in which an electrode body is accommodated, and the electrolytic solution is allowed to permeate into the electrode body. In some cases, an internal space of the exterior body is depressurized prior to injecting the electrolytic solution for the purpose of promoting the permeation of the electrolytic solution.

However, when the electrode body has been subjected to pressing for increasing the density, for example, the inside of the electrode body may fail to be sufficiently deaerated and a sufficient degree of difference in air pressure between the inside and the outside of the exterior body may not be secured. As a result, an effect of promoting the permeation of an electrolytic solution may not be achieved sufficiently by the depressurization.

In the electrode body according to the present disclosure, a pressure inside the electrode body is effectively reduced as a region corresponding to a projecting portion of the first electrode layer serves as an airway. As a result, a sufficient degree of difference in air pressure between the inside and the outside of the exterior body is secured and the permeation of an electrolytic solution into the electrode body is promoted.

### First Electrode Layer

The first electrode layer has a projecting portion that projects toward a side of the separator.

From the viewpoint of harnessing the function as an airway of a region corresponding to the projecting portion of the first electrode layer in an effective manner, the region corresponding to the projecting portion of the first electrode layer is preferably lower in density than a region around the projecting portion.

A state in which the region corresponding to the projecting portion of the first electrode layer is lower in density than the region around the projecting portion may be achieved by, for example, applying a lower pressure to the region corresponding to the projecting portion than a pressure applied to the region around the projecting portion; or applying no pressure to the region corresponding to the projecting portion, during a process of pressing the first electrode layer.

Examples of the method for forming the projecting portion at the first electrode layer include a method of applying a pressure to the first electrode layer using a roll having a recessed portion at a surface. According to the method, a projecting portion is formed at a portion over which the recessed portion of the roll passes (i.e., a portion to which no pressure or relatively small pressure is applied by a roll).

From the viewpoint of harnessing the function as an airway of the region corresponding to the projecting portion of the first electrode layer in an effective manner, the projecting portion preferably has a shape of a line, more preferably a shape of a straight line, when the first electrode is viewed at a side of the principal surface.

When the projecting portion has a shape of a line, an end portion (preferably both end portions) of the projecting portion is preferably disposed at an end face of the electrode body.

The number of the projecting portions to be provided to the first electrode layer is not particularly limited, and a single projecting portion or plural projecting portions may be provided to the first electrode layer.

For example, the first electrode layer may have plural projecting portions having a linear shape that are disposed in a striped pattern or a grid pattern.

The proportion of the projecting portion with respect to the principal surface of the first electrode layer is not particularly limited.

From the viewpoint of deaerating the inside of the electrode body in an effective manner, a proportion by area of the projecting portion, with respect to an area of the principal surface of the first electrode layer, is preferably 1% or more, more preferably 5% or more, further preferably 10% or more.

From the viewpoint of securing the energy density of a battery, a proportion by area of the projecting portion, with respect to an area of the principal surface of the first electrode layer, is preferably 30% or less, more preferably 25% or less, further preferably 20% or less.

When the first electrode layer has plural projecting portions, the aforementioned area of the projecting portion refers to a total area of plural projecting portions.

The thickness of the first electrode layer is not particularly limited, and may be selected from a thickness of typical electrode layers.

For example, the thickness of the first electrode layer at a region around the projecting portion may be selected from a range of from 10 μm to 200 μm.

The thickness of the first electrode layer at a region corresponding to the projecting portion is not particularly limited.

For example, the thickness of the first electrode layer at a region corresponding to the projecting portion may be selected from a range of from 110% to 150% of a thickness of the first electrode layer at a region around the projecting portion.

The electrode body may include plural first electrode layers. In that case, it is possible that some of the plural first electrode layers have a projecting portion, or it is possible that all of the plural first electrode layers have a projecting portion.

### Second Electrode Layer

The second electrode layer has a recessed portion at a position facing the projecting portion of the first electrode layer.

By providing the second electrode layer with the recessed portion at a position facing the projecting portion of the first electrode layer, the thickness of the electrode body, including the first electrode layer, the second electrode layer and the separator, may be equalized.

Examples of the method for forming the recessed portion at the second electrode layer include a method of applying a pressure to the second electrode layer using a roll having a projecting portion at a surface. According to the method, a recessed portion is formed at a portion over which the projecting portion of the roll passes.

The recessed portion provided at the second electrode layer preferably has a shape corresponding to the projecting portion provided at the first electrode layer. For example, when the projecting portion provided at the first electrode layer has a shape of a line, the recessed portion provided at the second electrode layer preferably has a shape of a line.

The thickness of the second electrode layer is not particularly limited, and may be selected from a thickness of typical electrode layers.

For example, the thickness of the second electrode layer at a region around the recessed portion may be selected from a range of from 10 μm to 200 μm.

The thickness of the second electrode layer at a region corresponding to the recessed portion is not particularly limited.

For example, the thickness of the second electrode layer at a region corresponding to the recessed portion may be selected from a range of from 50% to 90% of a thickness of the second electrode layer at a region around the recessed portion.

The electrode body may include plural second electrode layers. In that case, it is possible that some of the plural second electrode layers have a recessed portion, or it is possible that all of the plural second electrode layers have a recessed portion.

The second electrode layer may have a projecting portion that projects toward a side of the separator, in addition to the recessed portion. In that case, the first electrode layer may have a recessed portion at a position facing the projecting portion of the second electrode layer.

When the second electrode layer has a projecting portion, details and preferred embodiments thereof are the same as the details and preferred embodiments of the projecting portion at the first electrode layer.

When the first electrode layer has a recessed portion, details and preferred embodiments thereof are the same as the details and preferred embodiments of the recessed portion at the second electrode layer.

### Separator

The separator is disposed between the first electrode layer and the second electrode layer.

The type of the separator is not particularly limited, and may be selected from those commonly used as a separator for an electrode. For example, a microporous film formed of a resin such as polyethylene may be used as a separator.

The separator preferably has an ability to deform sufficiently according to the shape of the projecting portion of the first electrode layer and the recessed portion of the second electrode layer.

The thickness of the separator may be selected from 5 μm to 100 μm, for example.

### Active Material

The first electrode layer and the second electrode layer include either a negative electrode active material or a positive electrode active material.

When the first electrode layer is a negative electrode layer that includes a negative electrode active material, the second electrode layer is a positive electrode layer that includes a positive electrode active material. When the first electrode layer is a positive electrode layer that includes a positive electrode layer, the second electrode layer is a negative electrode layer that includes a negative electrode active material.

From the viewpoint of using the projecting portion of the first electrode layer as an airway, the first electrode layer is preferably a negative electrode layer.

The type of the negative electrode material is not particularly limited, and may be selected from those commonly used as a negative electrode active material for a battery.

Examples of the negative electrode active material include carbon materials and silicon. Examples of the carbon materials includes graphite, soft carbon and hard carbon.

The particle size of the negative electrode active material is not particularly limited, and may be selected from 5 μm to 30 μm, for example.

The type of the positive electrode material is not particularly limited, and may be selected from those commonly used as a positive electrode active material for a battery.

Examples of the positive electrode active material include composite oxides formed of lithium and a transition metal, and optionally other metals (hereinafter, also referred to as lithium transition metal composite oxides). Examples of the transition metal and other metals include Ni, Co, Mn, Al, B, Mg, Ti, V, Cr, Fe, Cu, Zn, Ga, Sr, Zr, Nb, In, Sn, Ta, W, and the like. Among these, lithium transition metal composite oxides including at least one selected from Ni, Co or Mn are preferred, and lithium transition metal composite oxides including Ni, Co and Mn (NCM, nickel-cobalt-manganese oxides) are more preferred.

Examples of the lithium transition metal composite oxide include lithium cobalt oxide (LiCoO₂), lithium nickel oxide (LiNiO₂), lithium manganese oxide (LiMnO₂), composite oxides thereof (LiCoₓNi_{y}Mn_{z}O₂, x+y+z=1), composite oxides further including an additional element M′ (LiCoₐNi_{b}Mn_{c}M′_{d}O₂, a+b+c+d=1, M′ is Al, Mg, Ti, Zr or Ge), spinel-type lithium transition metal composite oxides (LiMn₂O₄), and olivine-type lithium transition metal composite oxides (LiMPO₄, M is Co, Ni, Mn or Fe).

The positive electrode active material contained in the positive electrode layer may be one kind alone, or may be two or more kinds thereof.

The particle size of the positive electrode active material is not particularly limited, and may be selected from 5 μm to 30 μm, for example.

The first electrode layer and the second electrode layer may include a conductive material, as necessary.

Specific examples of the conductive material include carbon materials such as carbon black (such as acetylene black, thermal black and furnace black), carbon nanotube and graphite.

The conductive material contained in the first electrode layer and the second electrode layer may be one kind alone, or may be two or more kinds thereof.

The first electrode layer and the second electrode layer may include a binder as necessary.

Specific examples of the binder include polyvinylidene fluoride (PVdF), polyethylene, polypropylene, polyethylene terephthalate, cellulose, nitro cellulose, carboxymethyl cellulose, polyethylene oxide, polyepichlorohydrin, polyacrylonitrile, styrene-butadiene rubber (SBR), acrylonitrile-butadiene rubber (NBR), polyacrylate, polymethacrylate and polytetrafluoroethylene (PTFE).

The binder contained in the first electrode layer and the second electrode layer may be one kind alone, or may be two or more kinds thereof.

### Current Collector

The electrode body of the present disclosure may include a first current collector that contacts the first electrode layer at a side opposite to a side facing the separator.

The electrode body of the present disclosure may include a second current collector that contacts the second electrode layer at a side opposite to a side facing the separator.

The type of the first current collector and the second current collector is not particularly limited, and may be selected from those commonly used as a current collector for a battery. For example, a current collector containing cupper may be used as a current collector for a negative electrode, and a current collector containing aluminum may be used as a current collector for a positive electrode.

The thickness of the current collector may be selected from 5 μm to 50 μm, for example.

### Method for Producing Electrode Layer

The method for producing the electrode layer is not particularly limited, and may be selected from known methods.

For example, the electrode layer may be formed by applying an electrode composition, containing an active material, at one or both faces of a current collector.

The electrode layer may be subjected to a pressing treatment in order to increase the density of the electrode layer. In that case, a projecting portion may be formed at a specific region of the electrode layer during the pressing treatment, by reducing a degree of pressure or applying no pressure to the specific region.

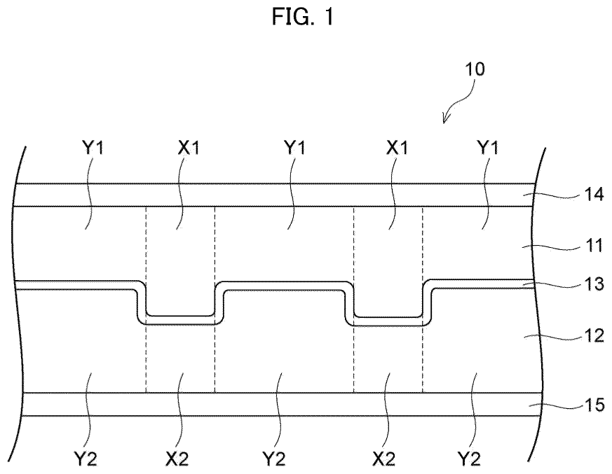

An exemplary configuration of the electrode body of the present disclosure is shown in FIG. 1.

Electrode body 10, illustrated in FIG. 1, includes first electrode layer 11, second electrode layer 12, and separator 13 disposed therebetween.

First current collector 14 is disposed at a side of first electrode layer 11 opposite to a side facing separator 13.

Second current collector 15 is disposed at a side of second electrode layer 12 opposite to a side facing separator 13.

First electrode layer 11 has a projecting portion that projects toward a side of separator 13, and second electrode layer 12 has a recessed portion at a position facing the projecting portion of first electrode layer 11.

The density of region X1, corresponding to the projecting portion of first electrode layer 11, is lower than region Y1 around the projecting portion.

The density of region X2, corresponding to the recessed portion of second electrode layer 12, is higher than region Y2 around the recessed portion.

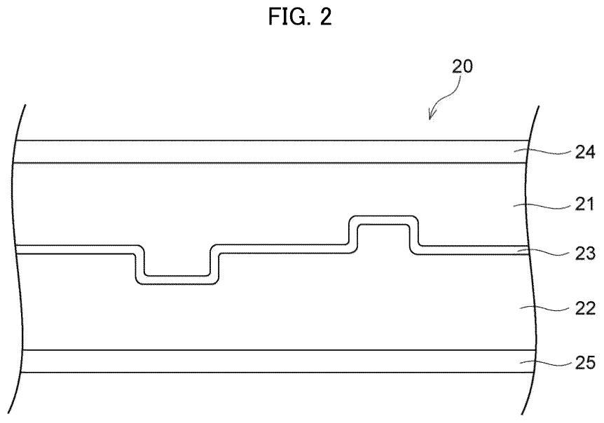

A further exemplary configuration of the electrode body of the present disclosure is shown in FIG. 2.

The electrode body 20, illustrated in FIG. 2, includes first electrode layer 21, second electrode layer 22, and separator 23 disposed therebetween.

First current collector 24 is disposed at a side of first electrode layer 21 opposite to a side facing separator 23.

Second current collector 25 is disposed at a side of second electrode layer 22 opposite to a side facing separator 23.

Second current layer 22 has a projecting portion that projects toward separator 23, in addition to a recessed portion at a position facing a projecting portion of first electrode layer 21. First electrode layer 21 has a recessed portion at a position facing the projecting portion of second electrode layer 22.

### Battery

The battery of the present disclosure is a battery that includes the electrode body of the present disclosure as described above.

The battery of the present disclosure includes, for example, an electrode body, an exterior body that accommodates the electrode body, and an electrolytic solution.

### Exterior Body

The type of the exterior body that accommodates an electrode body is not particularly limited, and may be selected according to the type of a battery.

In an embodiment, an exterior body having a sheet-like shape may be used.

Examples of an exterior body having a sheet-like shape include an exterior body including metal, and specific examples thereof include a layered body that has a metal layer containing a metal such as aluminum and a heat seal layer containing a resin that melts by heating (i.e., a laminate film). Therefore, the battery of the present disclosure may be a battery using a laminate film as an exterior body (i.e., a laminate battery).

The exterior body may be composed of a single member or composed of two or more members. For example, when the exterior body is a sheet-like object, the exterior body may be composed of a single sheet-shaped object or composed of two sheet-shaped objects.

As necessary, a recessed portion for accommodating an electrode body may be formed to the sheet-shaped exterior body by embossing.

Examples of a method for accommodating the electrode body in the exterior body using a sheet-shaped exterior body include, for example, the following Method 1 and Method 2.
Method 1: a method of, in a state in which the electrode body is disposed between one exterior body that has been folded in half or between two exterior bodies that have been superposed, joining the exterior body (or bodies) at a periphery of the electrode body.
Method 2: a method of inserting the electrode body into a bag that has been prepared by joining a periphery of one exterior body that has been folded in half or two exterior bodies that have been superposed.

### Electrolytic Solution

The type of the electrolytic solution is not particularly limited, and may be selected according to the type of the battery.

For example, a solution obtained by dissolving an electrolytic substance, such as LiPF₆, in a non-aqueous solvent, may be used as an electrolytic solution.

The battery of the present disclosure may be mounted at an electric vehicle. Hereinafter, an example in which the battery of the present disclosure is applied to an electric vehicle will be explained with reference to the drawings. In the following explanation, a “battery cell 20” corresponds to the battery of the present disclosure.

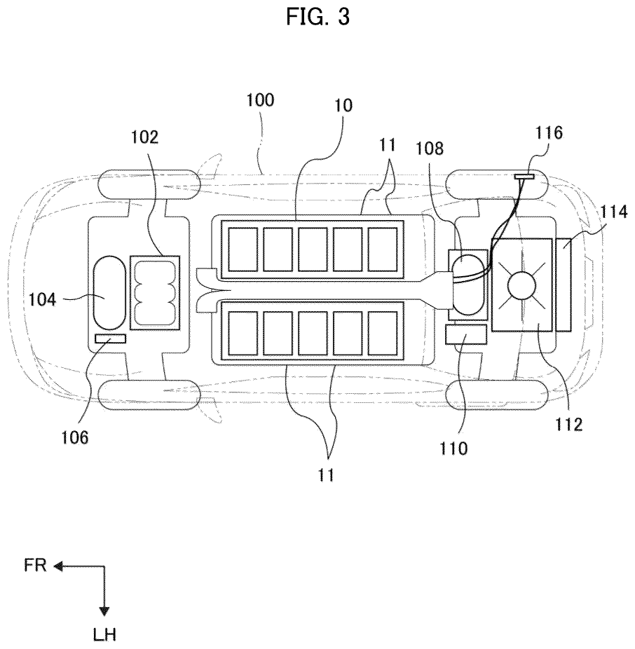

FIG. 3 is a schematic plan view illustrating a main part of a vehicle 100 to which a battery pack 10 according to an embodiment has been applied. As shown in FIG. 3, the vehicle 100 is an electric vehicle (battery electric vehicle (BEV)) in which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are disposed further toward a vehicle front side than the battery pack 10. Further, a motor 108, a gear box 110, an inverter 112, and a charger 114 are disposed further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

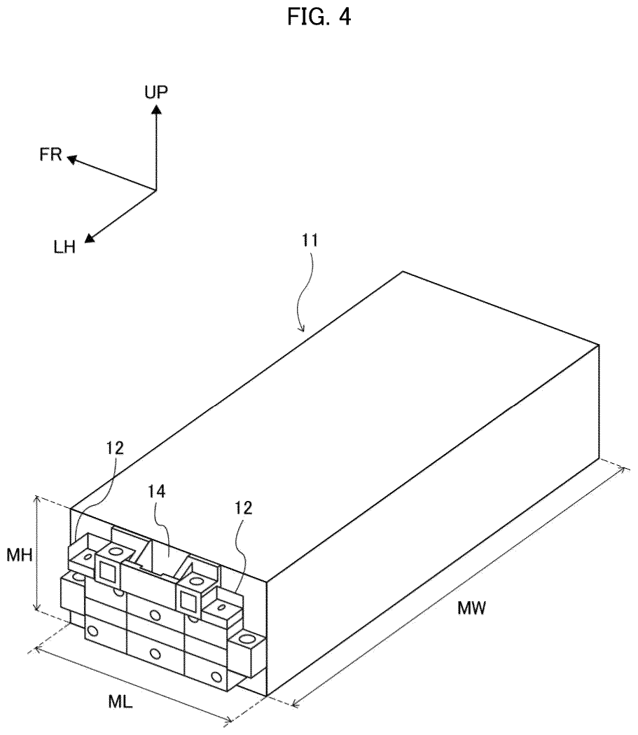

FIG. 4 is a schematic perspective view of a battery module 11. As shown in FIG. 4, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both ends of the battery module 11 in the vehicle width direction. A flexible printed circuit board 21, which will be described later, is connected to the connector 14. Furthermore, bus bars, which are not illustrated in the drawings, are welded to both ends of the battery module 11 in the vehicle width direction.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

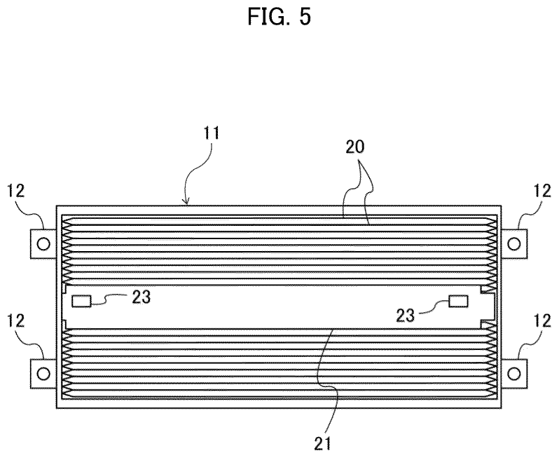

FIG. 5 is a plan view of the battery module 11 in a state in which an upper lid thereof has been removed. As shown in FIG. 5, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end ends of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are disposed at both end portions in the longitudinal direction of the battery module 11 and at the center portion in the longitudinal direction of the battery module 11, respectively.

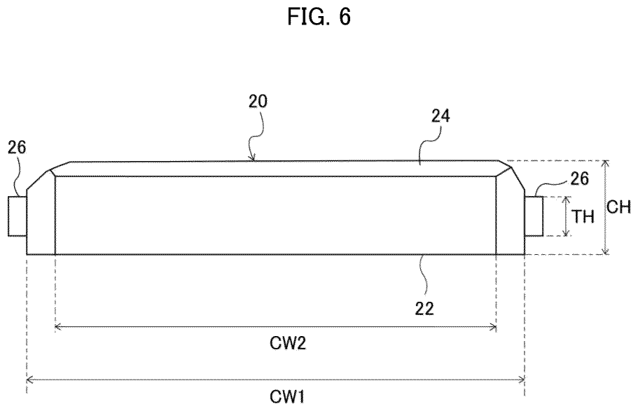

FIG. 6 is a schematic diagram in which a battery cell 20 that is accommodated in the battery module 11 is viewed from a thickness direction thereof. As shown in FIG. 6, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. An electrode body, comprising a first electrode layer, a second electrode layer, and a separator that is disposed between the first electrode layer and the second electrode layer,
the first electrode layer having a projecting portion that projects toward a side of the separator, and
the second electrode layer having a recessed portion at a position facing the projecting portion of the first electrode layer.

2. The electrode body according to claim 1, wherein, in the first electrode layer, a region corresponding to the projecting portion is lower in density than a region around the projecting portion.

3. The electrode body according to claim 1, wherein, in the second electrode layer, a region corresponding to the recessed portion is higher in density than a region around the recessed portion.

4. The electrode body according to claim 1, wherein the first electrode layer is a negative electrode layer and the second electrode layer is a positive electrode layer.

5. The electrode body according to claim 1, wherein the second electrode layer has a projecting portion that projects toward the side of the separator, and the first electrode layer has a recessed portion at a position facing the projecting portion of the second electrode layer.

6. A battery, comprising the electrode body according to claim 1.
